(19) United States
(12) Patent Application Publication
(10) Pub. No.: US 2013/0044738 A1
(43) Pub. Date: Feb. 21, 2013

(54) PHOTO KIOSK WIRELESS TRANSMISSION SYSTEM DESIGN

(71) Applicant: HSIEN-RONG LIANG, New Taipei City (TW)

(72) Inventor: HSIEN-RONG LIANG, New Taipei City (TW)

(21) Appl. No.: 13/210,353

(22) Filed: Aug. 15, 2011

(51) Int. Cl. H04W 84/02

(52) U.S. Cl. 370/338

(57) ABSTRACT

A photo kiosk wireless transmission system includes a mobile device and a data processing device. The mobile device includes an application program embedded therein and the data processing device includes a corresponding application program, so that transmission of multimedia data can be carried out between the mobile device and the data processing device through the corresponding application programs. To carry out the transmission, a Wi-Fi transmission device included in the mobile device and a Wi-Fi reception device included in the data processing device must be activated. As such, the multimedia data contained in the mobile device can be transmitted to the data processing device to allow the data processing device to carry out processing of the multimedia data (such as printing, storage, or uploading through the Internet to a community interaction platform), thereby improving convenience of use through changing the process and path of the known technology of multimedia data uploading.

### (a) TECHNICAL FIELD OF THE INVENTION

The present invention generally relates to a photo kiosk wireless transmission system, and more particularly to a photo kiosk wireless transmission system that employs Wi-Fi wireless transmission techniques to allow a mobile device to transmit multimedia data to a data processing device for photo processing.

### (b) DESCRIPTION OF THE PRIOR ART

The modern society is an era when the information technology and electronic industry are prosperous development and progress. High technology products and mobile communications that are developed based on the computer technology is being increasingly developed and play an important role in the modem living by shortening the distance of space and time between people.

Particularly, besides the basic function of communication, the mobile phones that are currently available in the market are also provided with a function of photographing. Photos that are captured with a mobile phone are often stored in the mobile phone. In addition, the mobile phones are no longer just a tool for conversation for the fast progress of technology brings in evolution of the regular mobile phones toward the so-called smart mobile phones. The smart mobile phones are often devised for network surfing so that the mobile phones are now versatile and allow users to better enjoy entertainment of multimedia.

Various models and brands of mobile phone are available in the market and these mobile phones are generally different, either slightly or essentially, in transmission specifications. Thus, to make an output and associated edition of the multimedia data from a mobile phone, a computer must be provided to access and retrieve the multimedia data stored in the mobile phone. To print photos stored in a mobile phone, the photos must be first transmitted to and stored in a portable memory device. The portable memory device is then brought to a photo printing shop and connected to a machine that is capable of photo printing. For output of regular text documents, the operation is pretty much the same as that for photos. Such a way of operation makes data output from the advanced smart mobile phone very troublesome and inconvenient.

### SUMMARY OF THE INVENTION

An objective of the present invention is to provide a photo kiosk wireless transmission system that uses Wi-Fi wireless transmission technology to transmit multimedia data contained in a mobile device to a data processing device to allow the data processing device to carry out processing of the multimedia data (such as printing, storage, or uploading through the Internet to a community interaction platform), thereby improving convenience of use through changing the process and path of the known technology of multimedia data uploading.

To achieve the above objective, the present invention provides a photo kiosk wireless transmission system, which comprises a mobile device, which receives an application program embedded therein and comprises a memory device for storing multimedia data and a Wi-Fi transmission device for transmitting the multimedia data; and a data processing device, which comprises an application program corresponding to the application program of the mobile device and also comprises a Wi-Fi reception device for receiving the multimedia data.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram of a preferred embodiment of the present invention.

FIG. 2 is a schematic view illustrating a mobile device that receives an application program embedded therein according to the present invention.

FIG. 3 is a schematic view illustrating a data processing device in connection with external devices according to the present invention.

FIG. 4 is a block diagram illustrating the present invention performing Wi-Fi wireless transmission and applied to a printing device.

FIG. 5 is a block diagram illustrating the present invention performing Wi-Fi wireless transmission and applied to a community interaction platform.

FIG. 6 is a schematic view illustrating installation of application program through Wi-Fi wireless transmission according to the present invention.

FIG. 7 is a block diagram illustrating the present invention performing Wi-Fi wireless transmission and applied to a storage device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

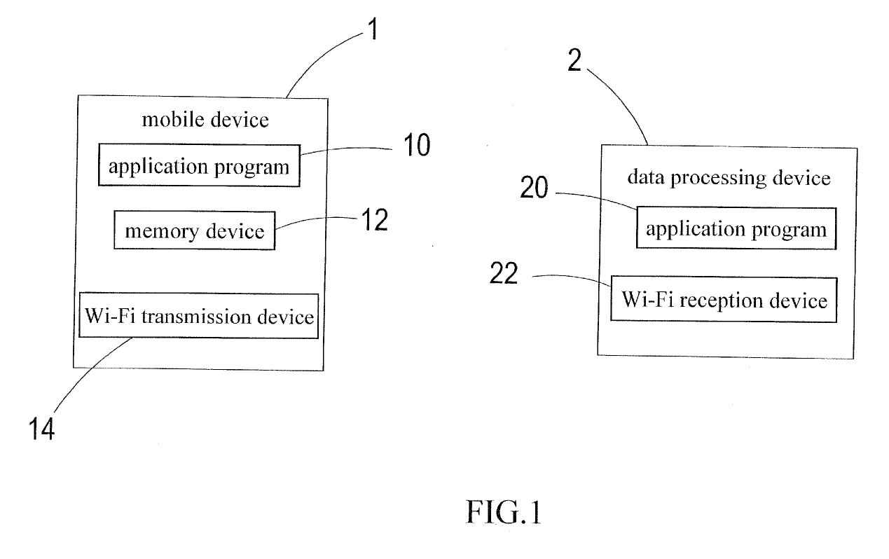

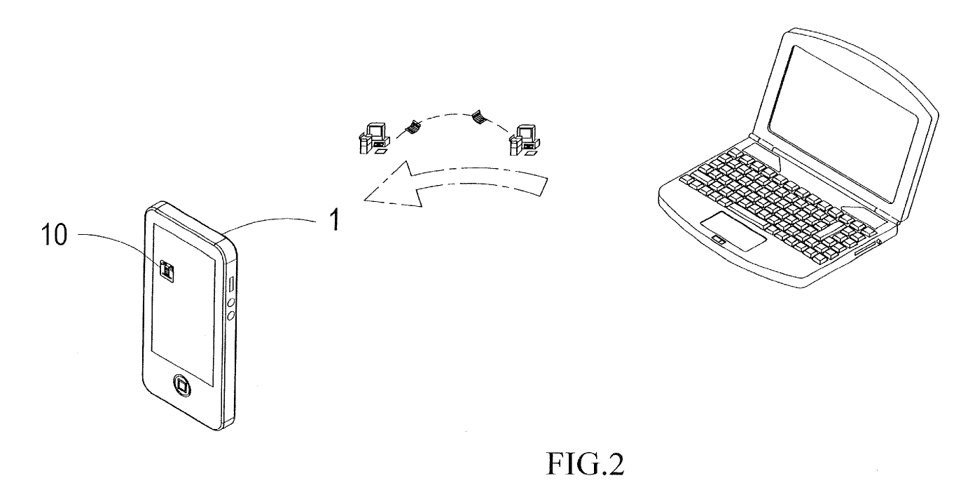

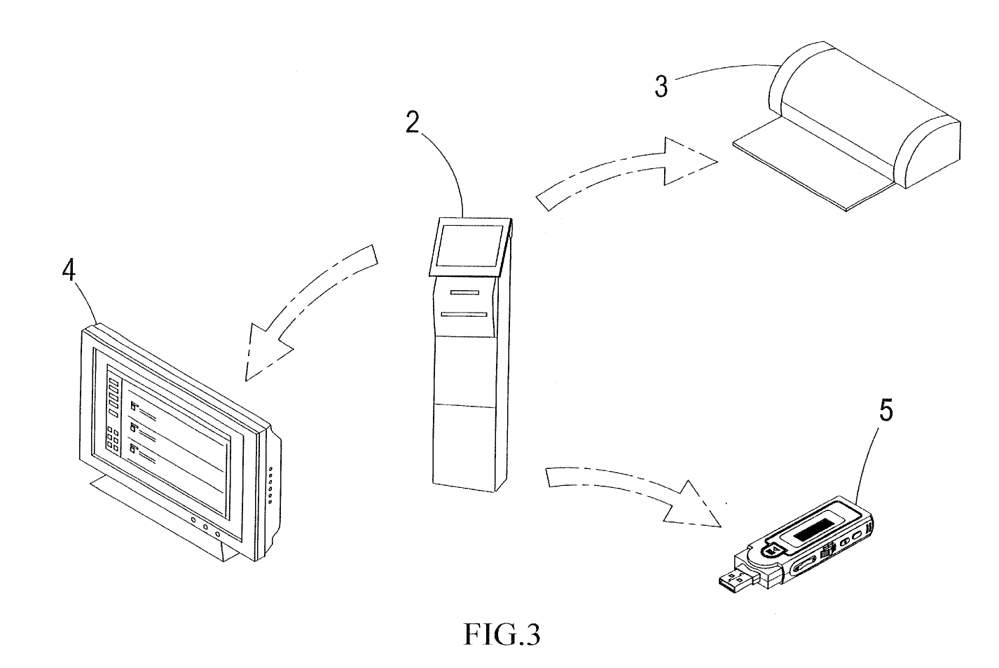

Referring to FIGS. 1, 2, and 3, which are respectively a block diagram of a preferred embodiment of the present invention, a schematic view illustrating a mobile device that receives an application program embedded therein, and a schematic view illustrating a data processing device in connection with external devices, the drawings clearly show that the present invention provides a photo kiosk wireless transmission system, which comprises a mobile device 1 (such as a mobile phone, a smart mobile phone, and a notebook computer), which receives in advance an application program 10 embedded therein and comprises a memory device 12 that stores multimedia data and a Wi-Fi transmission device 14 that transmits the multimedia data; and a data processing device 2, which comprises an application program 20 corresponding to the application program 10 and also comprises a Wi-Fi reception device 22 that receives the multimedia data.

The present invention may further comprise a printing device 3 that is connected to the data processing device 2 to output the multimedia data, a community interaction platform 4 that performs transmission and reception with respect to the data processing device 2 through the Internet for editing the multimedia data, and a storage device 5 (such as a data burning device, a universal serial bus (USB), and a mobile phone) that is connected to the data processing device 2 for output and storage of the multimedia data.

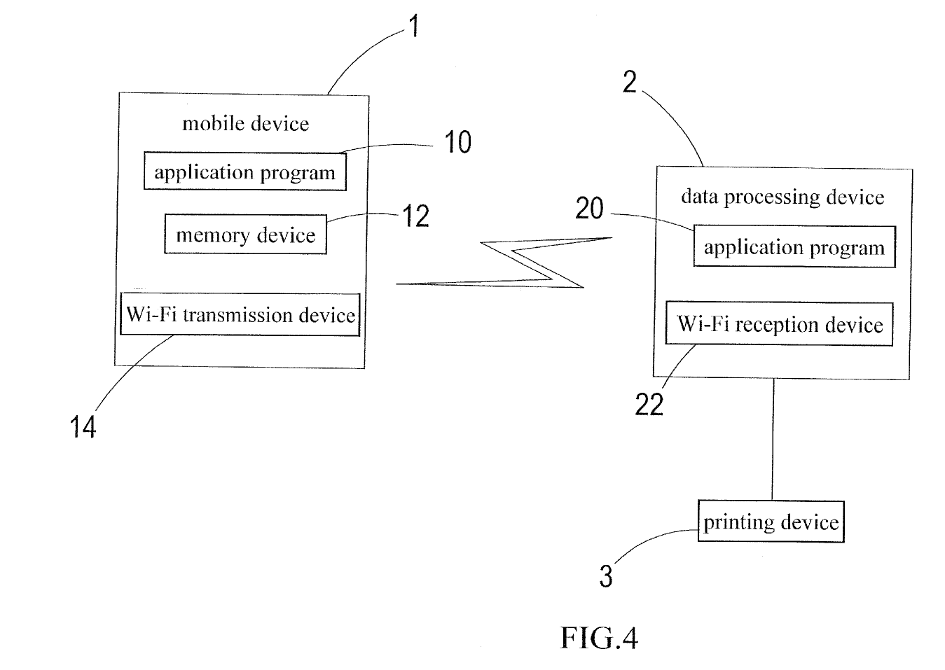

With the above arrangement, the use and operation of the present invention will be described as follows. Reference is also made to FIG. 4, which is a block diagram illustrating the present invention performing Wi-Fi wireless transmission, the drawing shows that in the above description, the application program 10 of the mobile device 1 is obtained by downloading through the Internet to a computer and then the application program 10 being installed in the mobile device 1 (a smart mobile phone being taken as an example). After completion of installation of the application program 10, the mobile device 1 may directly use the Wi-Fi transmission device 14 to establish connection with the Wi-Fi reception device 22 of the data processing device 2. At this moment, the mobile device 1 uses the Wi-Fi wireless transmission technology to seek and find the data processing device 2, and the application program 10 of the mobile device 1 connects the application program 20 of the data processing device 2 so as to establish transmission medium between the mobile device 1 and the data processing device 2. And then, multimedia data is transmitted from the memory device 12 through the Wi-Fi transmission device 14 and is received by the Wi-Fi reception device 22.

Since the data processing device 2 may be connected with a number of external devices of which an example is the printing device 3 mentioned above. When the Wi-Fi reception device 22 of the data processing device 2 receives image data (photos) supplied from the mobile device 1, the data processing device 2 forwards the image data to the printing device 3 to allow the image data to be printed out. In this way, a user may uses Wi-Fi wireless transmission technology to print multimedia data (photos) contained in the mobile device 1 (smart mobile phone) without adopting the conventional way of transmission.

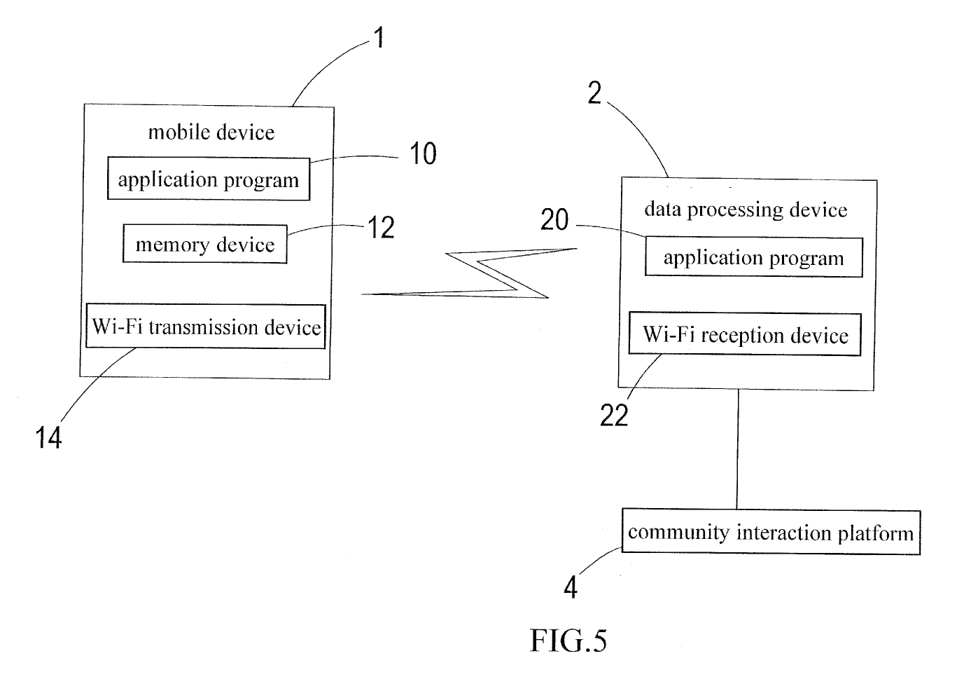

A different way of operation can be performed with the above described device. Referring now to FIG. 5, which is a block diagram illustrating the present invention performing Wi-Fi wireless transmission and applied to a community interaction platform, the drawing clearly shows that the application program 10 of the mobile device 1 is obtained by downloading through the Internet to a computer and then the application program 10 being installed in the mobile device 1 (a notebook computer being taken as an example). After completion of installation of the application program 10, the mobile device 1 may directly use the Wi-Fi transmission device 14 to establish connection with the Wi-Fi reception device 22 of the data processing device 2. At this moment, the mobile device 1 uses the Wi-Fi wireless transmission technology to seek and find the data processing device 2, and the application program 10 of the mobile device 1 connects the application program 20 of the data processing device 2 so as to establish transmission medium between the mobile device 1 and the data processing device 2. And then, multimedia data is transmitted from the memory device 12 through the Wi-Fi transmission device 14 and is received by the Wi-Fi reception device 22.

Since the data processing device 2 may be connected with a number of external devices of which an example is a community interaction platform 4 (such as Face Book, my space, Blog, Rss, or personal network website). When the Wi-Fi reception device 22 of the data processing device 2 receives image data (photos) supplied from the mobile device 1, the data processing device 2 forwards the image data to the community interaction platform 4 via for example the Internet to edit or share the image data with other friends through the community interaction platform 4, In this way, a user may use the Wi-Fi wireless transmission technology to upload multimedia data (photos) contained in the mobile device 1 (notebook computer) to the community interaction platform 4 without adopting the conventional way of transmission.

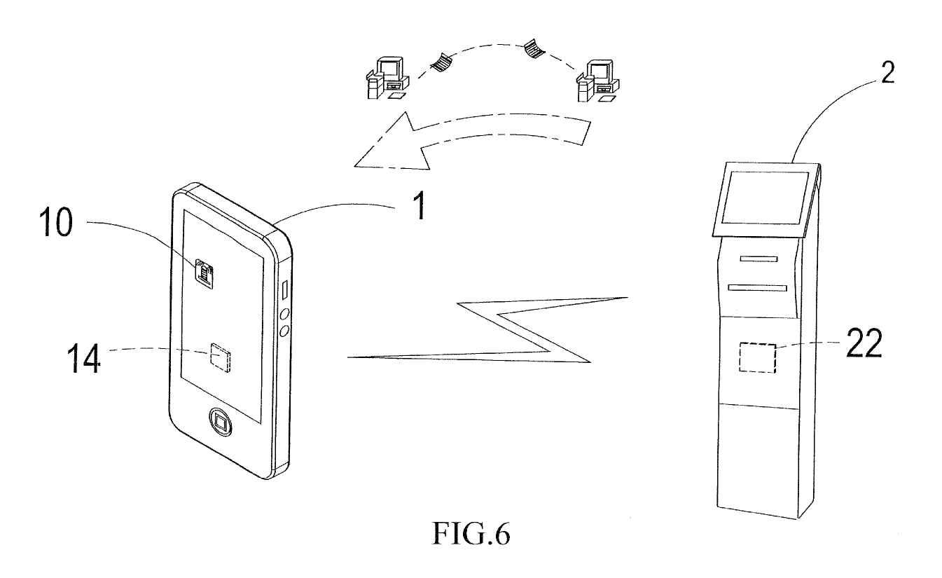

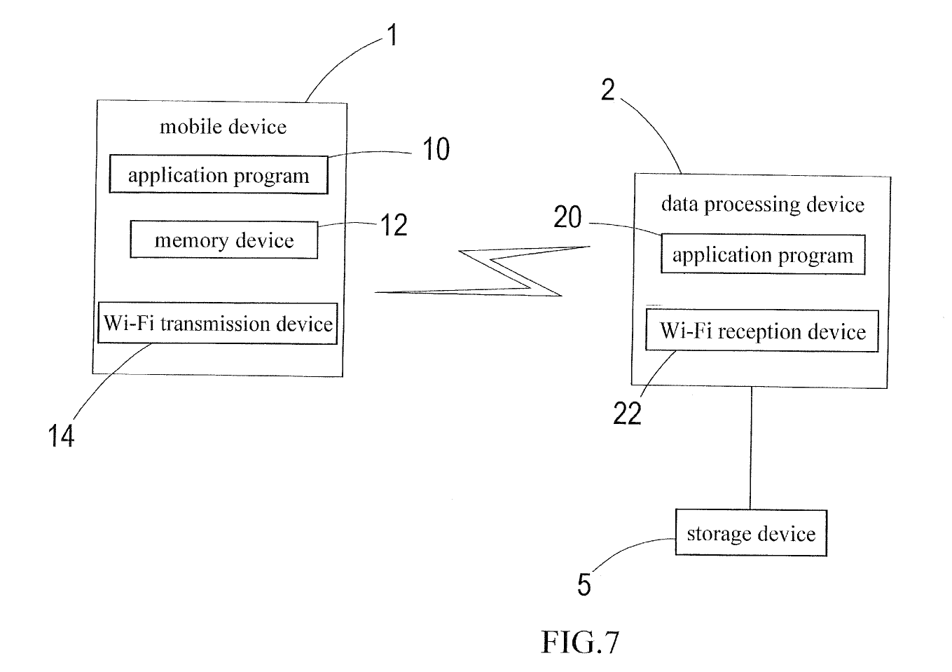

A further different way of operation can be performed with the above described device. Referring now to FIGS. 6 and 7, which are a schematic view illustrating installation of application program through Wi-Fi wireless transmission and a block diagram illustrating the present invention performing Wi-Fi wireless transmission and applied to a storage device, the application program 10 of the mobile device 1 can be obtained from the data processing device 2 through the Wi-Fi wireless transmission technology and the mobile device 1 may now directly carry out the installation on the mobile device 1 (a smart mobile phone being taken as an example). After completion of installation of the application program 10, the mobile device 1 may directly use the Wi-Fi transmission device 14 to establish connection with the Wi-Fi reception device 22 of the data processing device 2. At this moment, the mobile device 1 uses the Wi-Fi wireless transmission technology to seek and find the data processing device 2, and the application program 10 of the mobile device 1 connects the application program 20 of the data processing device 2 so as to establish transmission medium between the mobile device 1 and the data processing device 2. And then, multimedia data is transmitted from the memory device 12 through the Wi-Fi transmission device 14 and is received by the Wi-Fi reception device 22.

Since the data processing device 2 may be connected with a number of external devices of which an example is the storage device 5 (such as a data burning device, a universal serial bus (USB), and a mobile phone). When the Wi-Fi reception device 22 of the data processing device 2 receives text data supplied from the mobile device 1, the data processing device 2 forwards the text data through the Internet to the storage device 5 to allow the text data to be stored in the storage device 5. In this way, a user may uses Wi-Fi wireless transmission technology to store multimedia data (text data) contained in the mobile device 1 (smart mobile phone), and this may be used to replace the conventional way of transmission.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A photo kiosk wireless transmission system, comprising:
a mobile device, which receives an application program embedded therein and comprises a memory device for storing multimedia data and a Wi-Fi transmission device for transmitting the multimedia data; and
a data processing device, which comprises an application program corresponding to the application program of the mobile device and also comprises a Wi-Fi reception device for receiving the multimedia data.

2. The photo kiosk wireless transmission system according to claim 1 further comprising a printing device that is connectable to the data processing device to output the multimedia data.

3. The photo kiosk wireless transmission system according to claim 1 further comprising a community interaction platform that performs transmission and reception with respect to the data processing device through the Internet for editing the multimedia data.

4. The photo kiosk wireless transmission system according to claim 1 further comprising a storage device that is connectable to the data processing device for output and storage of the multimedia data.

5. The photo kiosk wireless transmission system according to claim 4, wherein the storage device comprises one of a data burning device, a universal serial bus (USB), and a mobile phone.

6. The photo kiosk wireless transmission system according to claim 1, wherein the mobile device comprises a mobile phone, a smart mobile phone, or a notebook computer.
